(19) United States
(12) Patent Application Publication
(10) Pub. No.: US 2012/0113322 A1
(43) Pub. Date: May 10, 2012

(54) Mixer To Transmit Audiovisual Data

(76) Inventors: Benjamin Abraham, Los Gatos, CA (US); Robert Campbell, Cupertino, CA (US); Yancy Chen, Cupertino, CA (US); Robert Campesi, San Jose, CA (US)

(21) Appl. No.: 13/383,390

(22) PCT Filed: Jul. 15, 2009
(86) PCT No.: PCT/US2009/050765

§ 371 Date: Jan. 10, 2012

(51) Int. Cl. H04N 5/265; H04N 5/50

(52) U.S. Cl. 348/552; 348/E05.056; 348/E05.097

(57) ABSTRACT

A mixer 110 can be connected to the computing system. The mixer can include a first input 115 to receive audiovisual data on a first channel from a content provider and a second input 120 to receive computer data. The mixer can transmit through an output 130 the audiovisual data received on the first channel and the computer data received from the second input on a second channel assigned by the mixer.

### BACKGROUND

Television can be transmitted by radio transmissions in the 7-1000 megahertz-range of the FM frequency band. A television channel is transmitted on a 6 MHz range of the FM frequency band. Televisions tuners can receive the radio transmissions and tune in a channel in the FM frequency band. Television channels are comprised of a video signal and an audio signal modulated to different frequencies. if a television tuner is tuned to a channel the tuner corresponds a television channel to the modulated frequency of the video signal and the modulated frequency of the audio signal so that the audiovisual data can be viewed on a television.

### BRIEF DESCRIPTION OF THE DRAWINGS

Some embodiments of the invention are described with respect to the following figures:

FIG. 1 is a block diagram of an exemplary embodiment of the invention;

FIG. 2 is a block diagram of an exemplary embodiment of the invention; and

FIG. 3 is a flow diagram of an exemplary embodiment of a method of the invention.

### DETAILED DESCRIPTION

A computer can store files including computer data that may include audiovisual data. The computer data may be in the form of a movie stored on the computer, for example. The computer data may also be music stored on the computer, for example.

Computers have become a source for audiovisual data however computers may not be located in close proximity to other audiovisual systems in a home such as the television. To view computer data on a television a connection can be made between a set top box and a computer through an Ethernet protocol. The Ethernet protocol can be transmitted wirelessly over a connection such as wi-fi or through a wired network such as a twisted pair network using category 5 twisted pair wires.

Transmitting computer data over a wireless connection can result in poor quality of the audiovisual data from interference created by other electromagnetic signals. A twisted pair network uses a physical wire between the computer and a set top box to decode the signal at the television.

To transmit the computer data to each of the televisions in a home a set top box is used to communicate through the wireless or twisted pair network with the computer storing the data. If a user was watching computer data on their television via a set top box and wanted to go watch the computer data on a different television the user would have to have a second set top box or would have to move the set top box from a first television to a second television.

An audiovisual input on a television can receive audiovisual data from a set top box that can receive computer data. For example the audiovisual input can be an HDMI port, an S-video port, or an RCA video port. The audiovisual input on a television is not connected to a television tuner that can decode multiple signals of audiovisual information for example separate television channels.

In one embodiment, a mixer is connected to a computer. The computer includes a memory to store computer data such as audiovisual data. The mixer may receive from a first input, audiovisual data on a first channel. The first channel can be in one embodiment a television channel from a content provider. The mixer can also receive computer data from an input connected to the memory on the computer. The computer data may be stored on a computer memory such as a hard drive. The mixer can transmit on an output a first channel that includes the audiovisual data received from the first input and a second channel that includes the computer data received from the second input.

If a television tuner is connected to the output of the mixer the television tuner can select the first channel to view the audiovisual data received from the first input or the television tuner can select the second channel that includes computer data received from the second input. Some homes include a coaxial cable to connect televisions to a content provider. For example a content provider may be a cable television provider or a satellite television provider. In one embodiment, the output of the mixer can be connected to a coaxial cable distributed through the house. If the output of the mixer is connected to the coaxial cable a television connected to the coaxial cable can display the computer data such as audiovisual data from the computer by selecting a channel with the computer data without using a set top box. If multiple televisions can be connected to the coaxial cable through a splitter they can all display the computer data by selecting the channel with the computer data without using a set top box.

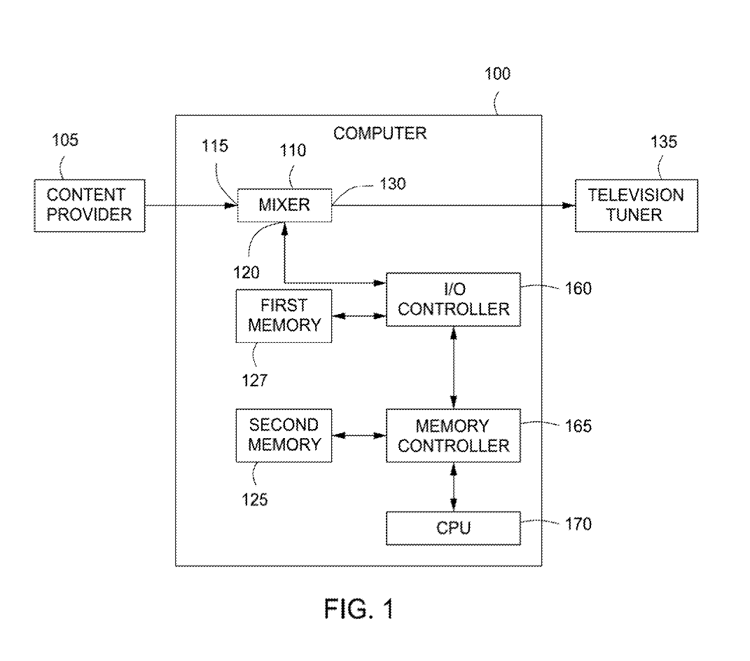

With reference to the figures, FIG. 1 is a block diagram of an exemplary embodiment of the invention. In one embodiment a computer 100 includes memory that may be a first memory 127 or a second memory 125. The first memory 127 may be for example a non-volatile memory such as a hard disk drive, an optical drive or a solid-state memory such as flash but may be other types of memory including volatile memory. The second memory may be for example a volatile memory, such as random access memory (ram) however the memory is not limited to these examples. The first memory 127 and second memory 125 can store computer data. The computer data stored on the first memory 127 or the second memory 125 can be audiovisual data, for example MPEG video files, MP3 audio files, Windows media files, or any other file type for storing audiovisual data.

The mixer 110 can include an input 120 that is connected to the first memory 127 though the input output controller 160 or the mixer 110 can include an input 120 that is connected to the second memory 125 through the input output controller 160 and the memory controller 165. In one embodiment, the mixer can read the computer data on the memory 165 through a direct memory access (DMA) process. In an alternative, embodiment the computer data is access on the memory by the central processing unit (CPU) 170 and then transmitted to the mixer 110 through the input output controller 160 and the memory controller 165. The computer data received by the mixer 110 can be converted from its encoding, for example MPEG video, to another encoding format, such as the advanced television systems committee (ATSC) format for digital televisions transmissions. For example the computer data may be encoded into a 16:9 image ratio of length to height and may have as many as 1920 pixels in length and 1080 pixels in height but the computer data may be encoded into other smaller sizes and other ratios. Encoding the computer data in a format for display on the television may include changing the display size of the video data, for example computer data for display on a computer monitor may have a display resolution that is compatible with a computer monitor but the resolution of a computer monitor may not be the same as the resolution of a television.

The mixer 110 includes a first input 115 to receive audiovisual data from a content provider 105. In one embodiment, the mixer includes a cable card that is a card to allow the mixer to receive cable television channels from a content provider. The content provider can be a cable television provider, a satellite television provider, a broadcast television provider such as over the air signals, or another provider of audiovisual content. The content provider signal received by the mixer is a signal that may be decoded by a tuner compatible with the national television standards committee (NTSC) analog television system, the ATSC digital television transmission, or another television transmission system, for example. The audiovisual data received from the content provider can be carried on a frequency modulated signal. In an NTSC analog television system there are 6 MHz between the frequency modulated signals carrying audiovisual data. The 6 MHz frequency modulated signals are refer to as television channels. For example television channel 2 uses a frequency of 54 to 60 MHz and television channel 3 uses a frequency of 60 to 66 MHz. In the ATSC television transmissions up to six sub-channels can be broadcast on a single 6 MHz signal.

The mixer 110 can assign a channel to the computer data received from the memory 125 through input 120. In one embodiment the mixer 110 determines an unused channel from the channels that are received from the content provider. The mixer may select from more than one unused channel by the amount of interference that may affect the signal on the unused channel.

The mixer 110 can include an output 130. The output 130 can transmit the audiovisual data on different channels. In one embodiment the channels transmitted through the output 130 include at least one channel received from the content provider 105 through the first input 115 and also includes the channel assigned by the mixer 110 that carries the computer data such as audiovisual data received, from a memory 125.

A television tuner 135 can be connected to the mixer 110 to receive the channels transmitted from the output 130. In one embodiment the television tuner can tune to the assigned channel and the television can display the computer data that was received from the memory 125 through the second input 120. The television tuner can tune to a first channel to display the audiovisual data received by the mixer from the content provider 105 through the first input 115.

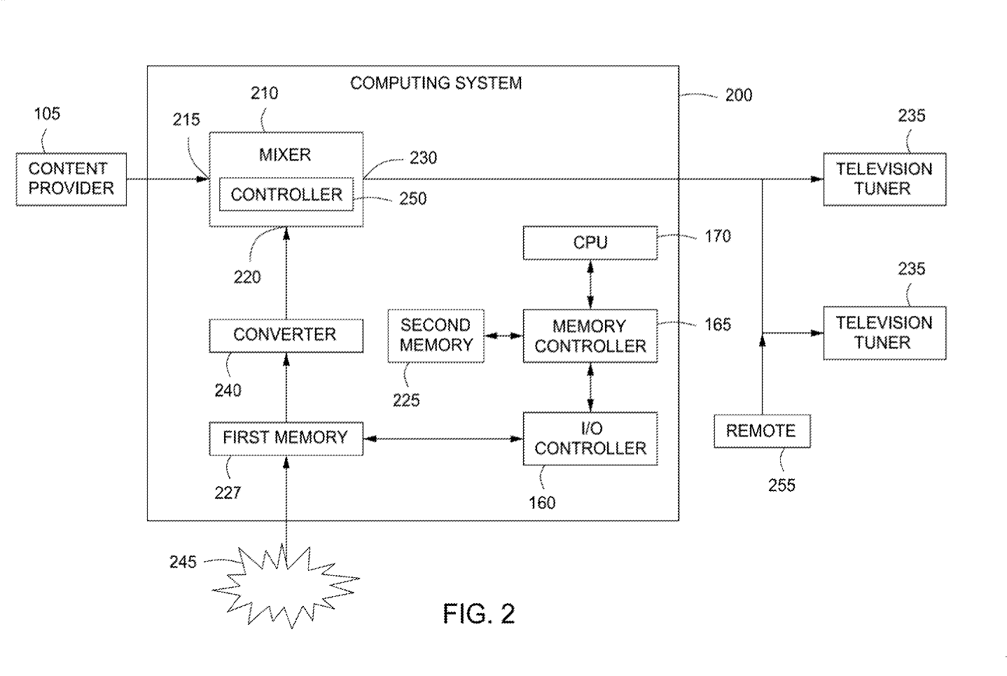

FIG. 2 is a block diagram of an exemplary embodiment of the invention. In one embodiment, the computer 200 includes a first memory 227 and a second memory 225 to store computer data. In one embodiment, the audiovisual data is received from the an external network 245 such as the internet and stored in the second memory 225. The first memory 227 may be a non-volatile memory for example a hard disk drive for storing the computer data received from the Internet 245 for later viewing and the second memory 225 and maybe a volatile memory such as random access memory (RAM) for temporary storage of the computer data received from the external network 245 before the computer data is converted to another format. The audiovisual data received from the internal network 245 may be streaming data. Streaming data is the audiovisual computer data that is received in a steady flow that the computer can access as the data is being transmitted.

In one embodiment, a converter 240 receives the computer data from the memory 225 and encodes the data from the current encoding format of the audiovisual data, such as MPEG video to a format compatible with a television tuner, for example, the advanced television systems committee (ATSC) format for digital televisions transmissions.

In one embodiment, the mixer 210 receives the computer data encoded in the television tuner compatible format from the converter 240 through input 220. The mixer 210 can assign a channel to the computer data received from the memory 225 through input 220. In one embodiment, the mixer 210 can determine an unused channel from the channels that are received from the content provider. The mixer may determine the unused channel to assign to the computer data by the amount of interference that may affect the signal on the unused channel. In one embodiment, the mixer can, receive more than one file of computer data from the converter 240. If the mixer 210 receives more than one file of computer data from the converter 240 the mixer can assign a channel for each file of computer data. For example the converter 240 can receive a first MPEG video file from the memory 225 and encode the MPEG video file to the ATSC format and the converter 240 can receive a second MPEG video file from the memory 225 and encode the second video file to the ATSC format. In one embodiment, the mixer 210 can then assign a first channel to the first MPEG video file in the ATSC format and assign a second channel to the second MPEG video file in the ATSC format.

The mixer can include a content provider input 215 to receive audiovisual data from a content provider. In one embodiment, the mixer can receive audiovisual data from multiple content providers. For example the mixer can receive audiovisual data from a cable television provider and audiovisual data from a satellite television provider. If the mixer receives audiovisual data from a first content provider and a second content provider the mixer can re-assigned a television channel from the first content provider that is also used by the second content provider. For example, if the first content provider includes audiovisual data received on channel 2 and the second content provider includes audiovisual data received on channel 2 the mixer can assign a different channel to the audiovisual data that is received from the first content provider on channel 2 to a channel that is not used by the second content provider such as a channel 3.

In one embodiment, the computer data received by the mixer 210 is a menu of computer data that is stored on the computer memory 225 or computer data that can be a received by the computer from an external network 245 source such as the interne. The menu can be assigned a channel by the mixer 210. The mixer 210 can transmit the menu through the output 230 to a television 235 or televisions 235 on the assigned channel with the transmission of other audiovisual data on other channels.

The television or televisions 235 can receive the audiovisual data on separate channels from the mixer 210. The televisions 235 can tune to the various audiovisual data by turning to different television channels. In one embodiment, a first television 235 can tune a first channel and the second television 235 can tune to a second channel. For example the first television 235 may tune to channel 2 that includes audiovisual data from the content provider 205 and the second television 235 may tune to channel 3 that includes computer data stored on the memory 225 and converted by the converter 240.

In one embodiment, the televisions 235 can be connected to the output of the mixer 210 through a coaxial cable. The coaxial cable may be an electrical cable with an inner connector surrounded by an insulating layer, a flexible material with a dielectric constant, all of which are surrounded by a conductive layer and covered with a thin insulating layer on the outside. The coaxial cable can be used to transmit multiple modulated television channels from the output of the mixer to the televisions. If there is more than one television connected to the output of the mixer a splitter may be used to split the signal output from the mixer to the different televisions.

In one embodiment, a remote control 255 may be connected to the output of the mixer 230. For example the remote control may be connected to the output of the mixer 210 through a coaxial cable connected to the output of the mixer 210. The signal from the remote control 255 can be received by a controller 250 in the mixer 210. The controller 250 can send a signal to the computing system to select computer data stored on the memory 225 to be sent to a converter 240. In some embodiments, a menu can be displayed on the televisions 235 by tuning to a channel assigned by the mixer to the menu and the menu can be manipulated by the remote control 255. For example the manipulation of the menu may be a highlighting the file name of audiovisual data and selecting a different file name on the menu to be highlighted. The highlighted file name that can be selected to be received by the converter 240 and assigned a channel by the mixer 210. In one embodiment, the remote control 255 is connected to the computer 200 by a wireless connection. For example, the remote control can be hand held and may be battery powered to transmit signals to the computer for selecting audiovisual data to send to the converter 240.

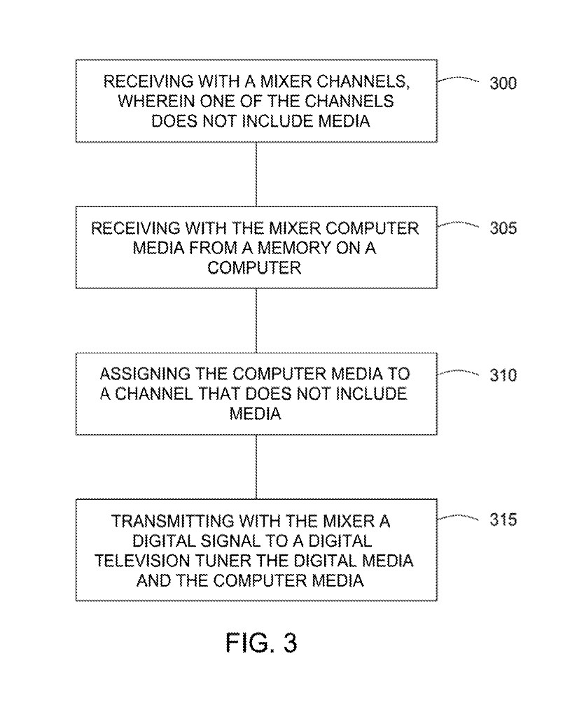

FIG. 3 is a flow diagram of an exemplary embodiment of a method of the invention. The mixer can receive channels and at least one of the channels received by the mixer does not include audiovisual data (at 300). The mixer can receive computer data from memory on a computer (at 305). The computer data from the memory can be in the format that the computer data was in when stored in the computer memory or the audiovisual data may be converted with a converter to a format that is compatible with television tuners. Converting the computer data to a format that is compatible with television tuners may include decoding the computer data and encoding the decoded data into the format that is compatible with the television tuners.

The mixer can assign the audiovisual data to a channel that does not include audiovisual data (at 310). In one embodiment the mixer determines which channels have audiovisual data and selects a channel from the remaining channels that do not have audiovisual data. The selected channel can be assigned to the audiovisual data that is received from the computer memory. The mixer transmits the audiovisual data from the provider and the audiovisual data from the computer to a television tuner (at 315).

The television tuner can be connected to the output of the mixer to receive the audiovisual data from the mixer. The audiovisual data from a content provider and computer data received by the television tuner is on multiple channels. The television tuner can tune to one of the channels with the audiovisual data from a content provider or a channel with computer data. The audiovisual data on the channel that is tuned to can be displayed on the television. In one embodiment, the audiovisual data on the channel may be a menu of computer data that is stored on the computer memory. A user may select audiovisual data to display on the television from the menu displayed on a channel using a remote. The user may also select audiovisual data from the content provider by selecting a channel with the television tuner.

In one embodiment the computer includes a monitor connected to the video card of the computer. The monitor can display a desktop of a computer operating system. In one embodiment the mixer does not display the same data that is displayed on the computer monitor. For example, the computer monitor may be displaying a text document that is being edited and the mixer is receiving audiovisual data from the computer memory. A television connected to the output of the mixer can tune to the channel assigned by the mixer to the computer data from the memory on the computer and view the computer data on the television without interrupting the other tasks being performed by the computer, for example editing a text document. In an alternative embodiment the computer data that is received by the mixer can be the image of the computer desktop. If the image of the computer desktop is received by the mixer then the television can tune to a channel on the television to display the computer desktop. If the television is displaying a computer desktop the remote to select computer data may operate as a pointing device to move a cursor on the desktop.

The techniques described above may be embodied in a computer-readable medium for configuring a computing system to execute the method. The computer readable media may include, for example and without limitation, any number of the following: magnetic storage media including disk and tape storage media; optical storage media such as compact disk media (e.g., CD-ROM, CD-R, etc.) and digital video disk storage media; holographic memory; nonvolatile memory storage media including semiconductor-based memory units such as FLASH memory, EEPROM, EPROM, ROM; ferromagnetic digital memories; volatile storage media including registers, buffers or caches, main memory, RAM, etc. Other new and various types of computer-readable media may be used to store and/or transmit the software modules discussed herein. Computing systems may be found in many forms including but not limited to mainframes, minicomputers, servers, workstations, personal computers, notepads, personal digital assistants, various wireless devices and embedded systems, just to name a few.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A system comprising:
a computing system with memory to store audiovisual data; and
a mixer 110 connected to the computer system and including:
a first input 115 to receive audiovisual data on a first channel from a content provider;
a second input 120 to receive computer data; and
an output 130 to transmit the audiovisual data received on the first channel and the computer data received from the second input on a second channel assigned by the mixer.

2. The system of claim 1 wherein the mixer 110 detects the first digital channel and automatically assigns the second digital channel to an unused channel from the first input.

3. The system of claim 1 further comprising a converter 240, connected to the mixer, to output the computer data in a format compatible with a television tuner.

4. The system of claim 1 further comprising a television tuner 135 connected to the output to receive the first channel and the second channel.

5. The system of claim 4 further comprising a coaxial cable to connect the output to the television tuner 135.

6. The system of claim 4 wherein the television tuner 135 is compatible with an advanced television systems committee (ATSC) format.

7. A method comprising:
receiving with a mixer 110 channels including audiovisual data, wherein one of the channels does not include the audiovisual data;
receiving with the mixer computer data from a memory 125 on a computing system;
assigning the computer data to a channel that does not include audiovisual data; and
transmitting with the mixer a signal to a television tuner 135 the audiovisual data received on the channels and the computer data received from the memory.

8. The method of claim 7 wherein assigning the computer data to a channel that does not include computer data is done automatically.

9. The method of claim 7 further comprising receiving audiovisual data from the Internet 245.

10. The method of claim 7 further comprising reassigning the audiovisual data on the channels to different channels.

11. The method of claim 7 further comprising encoding the computer data in a format compatible with a television tuner 135.

12. The method of claim 7 further comprising connecting the mixer to a content provider 205.

13. A computer readable medium comprising instructions that if executed cause a mixer 110 to:
receive audiovisual data from a content provider 205 on a first television channel;
receive audiovisual data from memory 125 on a computing system;
automatically assign a second television channel to the audiovisual data from memory on the computer; and
transmit from an output the audiovisual data on the first television channel and the computer data on the second television channel.

14. The computer readable medium of claim 13 further comprising instructions that if executed cause the mixer 110 to encode computer data in a format compatible with television tuners.

15. The computer readable medium of claim 13 further comprising instructions that if executed cause the mixer to transmit a menu of computer data files as the computer data.
